(19) United States
(12) Patent Application Publication
(10) Pub. No.: US 2013/0069906 A1
(43) Pub. Date: Mar. 21, 2013

(54) TOUCH SENSING DEVICE AND ELECTRONIC DEVICE

(71) Applicants: Jiaying Tu, Longyan (CN); Yau-Chen Jiang, Zhubei (TW); Pingping Huang, Sanming (CN)

(72) Inventors: Jiaying Tu, Longyan (CN); Yau-Chen Jiang, Zhubei (TW); Pingping Huang, Sanming (CN)

(21) Appl. No.: 13/442,863

(22) Filed: Apr. 10, 2012

(30) Foreign Application Priority Data
Sep. 16, 2011 (CN) 201110281474.4

(51) Int. Cl. G06F 3/044

(52) U.S. Cl. 345/174

(57) ABSTRACT

A touch sensing device is disclosed. The touch sensing device comprises a touch sensing circuit layer disposed on a lower surface of a substrate; and a shielding structure disposed under the touch sensing circuit layer along with the touch sensing circuit layer at the same side of the substrate, wherein the shielding structure comprises a conductive layer and a supporting layer. An electronic device having the touch sensing device is also provided. The touch sensing device of the present disclosure can not only provide shielding function but also can avoid generating improper background capacitance, thereby preventing reduction or failure of touch sensitivity of the touch sensing device.

This application claims the benefit of the People's Republic of China Application No. 201110281474.4, filed on Sep. 16, 2011.

### BACKGROUND OF THE INVENTION

1. Field of the Invention

The present disclosure relates to an input device. More particularly, the present disclosure relates to a touch sensing device and an electronic device applying the touch sensing device.

2. Description of the Related Art

A touch sensing device allows a user to perform an input function by a finger or a stylus to complete transmission of information. Generally, touch sensing devices can be classified into resistive, capacitive, acoustic-wave and optical touch sensing devices, which are based on different sensing methods. FIG. 1 shows a schematic sectional view of a conventional touch sensing device 10 which has a single glass. The touch sensing device 10 includes a substrate 100 having an upper surface 100a and a lower surface 100b. A touch sensing circuit layer 102 is disposed on the upper surface 100a of the substrate 100. As the touch sensing device 10 can be interfered by outside noise (such as a display device or other external devices), a conductive layer 104 is disposed on the lower surface 100b of the substrate 100 to prevent the sensing device 10 from outside noise.

However, the touch sensing circuit layer 102 and the conductive layer 104 are usually formed directly on the upper surface 100a and the lower surface 100b of the substrate 100 respectively by thin film depositing, lithography, etching, sputtering, printing, and the like. As the distance between the conductive layer 104 and the touch sensing circuit 102 is too short in the touch sensing device 10, a large background capacitance is formed between the conductive layer 104 and the touch sensing circuit layer 102, leading to a reduction or failure of touch sensitivity of the touch sensing device 10.

Thus, it is necessary to seek a new touch sensing device structure to improve or avoid the above problems.

### SUMMARY OF THE INVENTION

In order to solve above said problems, a shielding structure is adopted in the present disclosure to avoid generation of background capacitance. A touch sensing device of the present disclosure comprises a touch sensing circuit layer disposed on a lower surface of a substrate; and a shielding structure disposed under the touch sensing circuit layer at the same side of the substrate, wherein the shielding structure comprises a conductive layer and a supporting layer.

In another embodiment of the present disclosure, a touch sensing device comprises a touch sensing circuit layer; and a shielding structure comprising a conductive layer and a supporting layer, wherein the supporting layer is resistant to background capacitance and has a thickness that forms a safe interval between the touch sensing circuit layer and the conductive layer.

In another embodiment of the present disclosure, an electronic device comprises a display device; a touch sensing device disposed on and electrically coupled to the display device, wherein the touch sensing device comprises a touch sensing circuit layer; and a shielding structure comprising a conductive layer and a supporting layer, wherein the supporting layer has a resistance to background capacitance and has a thickness that forms a safe interval between the touch sensing circuit layer and the conductive layer.

By means of the shielding structure, the touch sensing device of the present disclosure not only can provide shielding function but also can avoid generation of improper background capacitance, thereby preventing the touch sensing device from reduction or failure in touch sensitivity.

### BRIEF DESCRIPTION OF THE DRAWINGS

For those skilled in the art to understand this disclosure, numerous embodiments are described below, annexing drawings to minutely illustrate the matters of the disclosure and the purpose thereof.

FIG. 1 shows a schematic sectional view of a conventional touch sensing device;

FIG. 2 shows a schematic sectional view of a touch sensing device in accordance with one embodiment of the present disclosure;

FIG. 3 shows a schematic sectional view of a touch sensing device in accordance with another embodiment of the present disclosure;

FIG. 4 shows a schematic sectional view of a touch sensing device in accordance with another embodiment of the present disclosure; and

FIG. 5 shows a schematic block diagram of an electronic device which has a touch sensing device in accordance with one embodiment of the present disclosure.

### DETAILED DESCRIPTION OF THE EMBODIMENTS

The following description is to illustrate an image display system in accordance with the embodiments of the present disclosure. However, it can be easily understood that the embodiments provided in the present disclosure are only used for illustrating manufacturing and using of the present disclosure by specific methods but not to limit the scope of the present disclosure.

FIG. 2 shows a schematic sectional view of a touch sensing device in accordance with one embodiment of the present disclosure. The touch sensing device 20 comprises a substrate 200, a touch sensing circuit layer 207 and a shielding structure 215. In the preferred embodiment, the substrate 200 is used as a top protection plate. The substrate 200 has an upper surface 200a and a lower surface 200b, opposite to the upper surface 200a. The upper surface 200a is used as a touch surface for direct touching of a user by using a finger or a stylus. The touch sensing circuit layer 207 is disposed on the lower surface 200b of the substrate 200. The shielding structure 215 is disposed below the touch sensing circuit layer 207 and is disposed along with the touch sensing circuit layer 207 at the same side of the substrate 200. The shielding structure 215 comprises a supporting layer 212 and a conductive layer 214. In one embodiment, the substrate 200 can be made of a transparent material, such as glass, quartz, or other flexible or inflexible polymer transparent materials. In other embodiments, the substrate 200 can also be made of a non-transparent material.

The touch sensing circuit layer 207 is disposed on the lower surface 200b of the substrate 200. In different embodiments, the touch sensing circuit layer 207 can be designed into a touch sensing circuit with different sensing types such as resistive type, capacitive type, acoustic wave type, optical type and the like. In the preferred embodiment, taking capacitive touch sensing circuit as an example, the touch sensing circuit layer 207 can be formed on the lower surface 200b of the substrate 200 through a process of thin film depositing, lithography, etching and the like. The touch sensing circuit layer 207 can comprise an electric connection layer 202, a capacitive dielectric layer 204, and a sensing electrode layer 206. The electric connection layer 202 can be a patterned conductive layer, a metal layer, or made of other conventional conductive materials. The electric connection layer 202 can be separated from the substrate 200 by an insulation layer (not shown). In order to simplify the drawing, the electric connection layer 202 is only shown as a flat layer.

The capacitive dielectric layer 204 is disposed below the electric connection layer 202. In one embodiment, the capacitive dielectric layer 204 can be a single layer such as a silicon oxide layer, a silicon nitride layer, or other transparent insulating polymer layer. In other embodiments, the capacitive dielectric layer 204 can have a multi-layer structure such as stacked silicon oxide layers, silicon nitride layers, or other transparent insulating polymer layers or their combinations.

The sensing electrode layer 206 is disposed below the capacitive dielectric layer 204, thereby sandwiching the capacitive dielectric layer 204 between the electric connection layer 202 and the sensing electrode layer 206. Capacitance is formed between the sensing electrode layer 206 and the finger or stylus on the touch surface when the finger or the stylus is placed on the touch surface. The sensing electrode layer 206 can comprise a plurality of sensing electrodes. The sensing electrodes can be arranged along two different directions, wherein the sensing electrodes along one of these two directions can be connected by the electric connection layer 202. The sensing electrodes can be formed by patterning a transparent conductive layer (such as ITO layer or IZO layer) or non-transparent conductive layer (such as metal layer) through the process of lithography and etching. In order to simplify the drawing, the sensing electrode layer 206 is also only shown as a flat layer.

In other embodiments, the touch sensing circuit layer 207 can comprise a first sensing electrode layer, a capacitive dielectric layer and a second sensing electrode layer. The first sensing electrode layer comprises a plurality of first sensing electrodes arranged along a first direction. The second sensing electrode layer comprises a plurality of second sensing electrodes arranged along a second direction. The capacitive dielectric layer is sandwiched between the first sensing electrode layer and the second sensing electrode layer.

In the above embodiments, shapes of the sensing electrodes can include any geometrical shape or their combinations.

The supporting layer 212 can be made of polyethylene terephthalate (PET), polymethylmethacrylate (PMMA) or glass and thickness of the supporting layer 212 can be between 0.05 mm-2.0 mm.

The conductive layer 214, which is used for preventing interference of noise from display device (not shown) or an external device, can be a continuous flat layer or have a mesh structure. The conductive layer 214 can be made of a transparent or non-transparent material. The transparent material can comprise but not be limited to: indium tin oxide (ITO), indium zinc oxide (IZO), cadmium tin oxide (CTO), aluminum zinc oxide (AZO), indium tin zinc oxide (ITZO), zinc oxide, cadmium oxide, hafnium oxide (HfO), indium gallium zinc oxide (InGaZnO), indium gallium zinc magnesium oxide (InGaZnMgO), indium zinc magnesium oxide (InZnMgO) or indium gallium aluminum oxide (InGaAlO). Thickness of the conductive layer 214 can be between 0.05 mm-0.3 mm.

The touch sensing device 20 provided in the present disclosure further comprises an adhesive layer 210 which is sandwiched between the touch sensing circuit layer 207 and the shielding structure 215. The adhesive layer 210 is made of an optically clear adhesive (OCA) comprising an acrylic resin, wherein thickness of the adhesive layer 210 can be between 0.03 mm-1.0 mm.

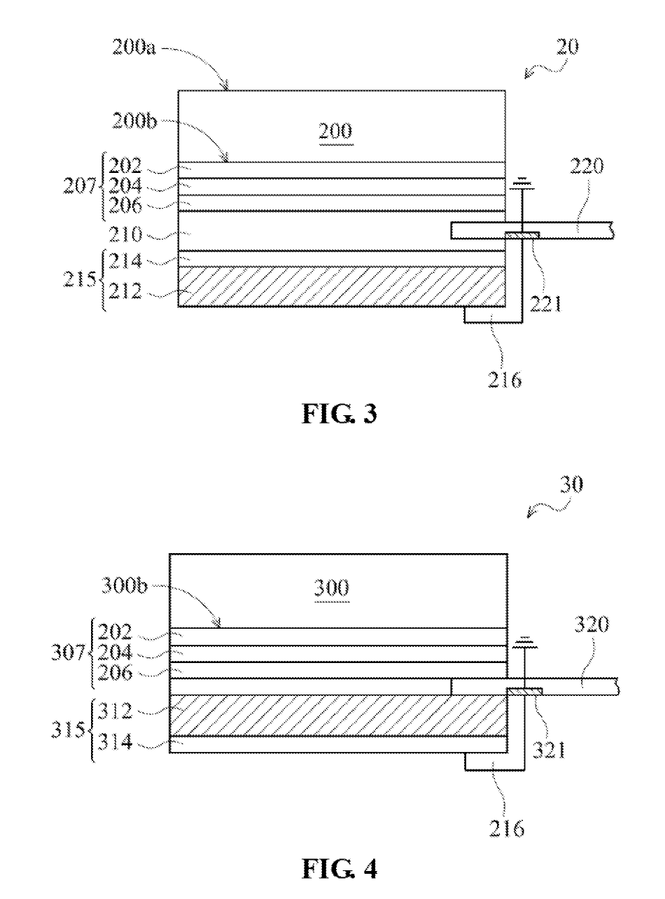

In one embodiment, referring to FIG. 2, supporting layer 212 is sandwiched between adhesive layer 210 and conductive layer 214, and the supporting layer 212 is integrated with an adhesive layer 210, jointly forming resistance to background capacitance, of thickness of 0.03 mm-3.0 mm. In another embodiment, referring to FIG. 3, a conductive layer 214 is sandwiched between an adhesive layer 210 and a supporting layer 212.

In above embodiments, by adjusting thickness of the supporting layer 212 and/or thickness of the adhesive layer 210, improper background capacitance, which is formed between the conductive layer 214 and the touch sensing circuit layer 207 in the shielding structure 215 can be avoided or eliminated to prevent reduction or failure of touch sensitivity of the touch sensing device 20.

The touch sensing device 20 further comprises a flexible printed circuit (FPC) 220, which can be electrically connected to the touch sensing circuit layer 207 through a conductive film (not shown), such as an anisotropic conductive film (ACF). Moreover, the conductive layer 214 can be electrically connected to a grounding pad 221 of the flexible printed circuit 220 through a connection layer 216 such as an anisotropic conductive film (ACF), to ground electromagnetic interference signals from the display device (not shown) or external environment through the circuit of the flexible printed circuit 220, thus achieve the purpose of preventing noise.

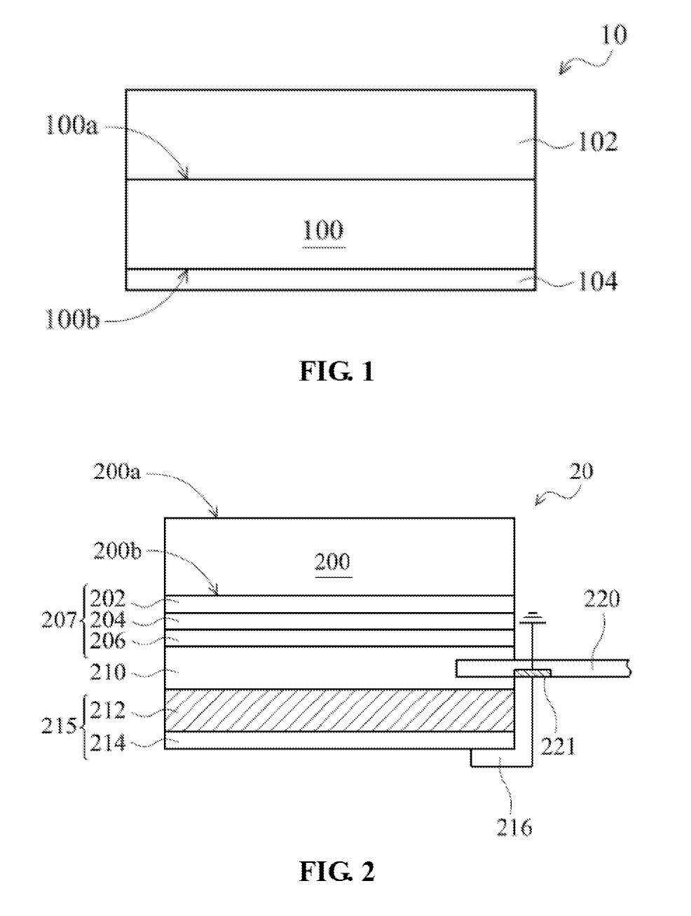

According to the above embodiments, the touch sensing device 20 adopts a single substrate 200 to provide a touch surface and a disposed surface for the touch sensing circuit layer 207 at the same time, compared with a conventional touch sensing device, which can only be operated by providing a top lens. Thus the touch sensing device 20 can omit the top lens, thereby effectively reducing thickness and manufacturing cost of the device. Moreover, replacing the conductive layer 104, which is used for preventing noise and directly covering the lower surface 100b of the substrate 100 in the conventional touch sensing device 10 (as shown in FIG. 1), with a shielding structure 215, not only simplifies the manufacturing process but also avoids generation of improper background capacitance. Thus, compared with the conventional touch sensing device, which has a single glass, reduction or failure of touch sensitivity of the touch sensing device can be prevented and quality of the touch sensing device can be improved. Besides, the shielding structure 215 does not directly cover the substrate 200 or the touch sensing circuit layer 207, but is attached to the touch sensing circuit layer 207 through the adhesive layer 210. If the adhesive layer 210 is made up of an optically clear adhesive (OCA), which can be pasted repeatedly, thickness of the adhesive layer 210 and/or thickness of the supporting layer 212 in the shielding structure 215 can be adjusted so as to timely eliminate or weaken the generated background capacitance and thus solve the existing problem which does not allow easy adjustment of the thickness of the substrate as, in the existing technology, the touch sensing circuit layer and the conductive layer are directly formed on the upper and the lower surfaces of the substrate.

FIG. 4 shows a schematic sectional view of a touch sensing device in accordance with another embodiment of the present disclosure. A touch sensing device 30 comprises a touch sensing circuit layer 307 and a shielding structure 315. The shielding structure 315 further comprises a supporting layer 312 and a conductive layer 314. The supporting layer 312, with a resistance to background capacitance, has a thickness that forms a safe interval between the touch sensing circuit layer 307 and the conductive layer 314 so that no background capacitance can be generated between the touch sensing circuit layer 307 and the conductive layer 314. Meanwhile, in order to optimize thickness of the touch sensing device 30, the safe interval should not be too large. Generally, if allowable smallest background capacitance is generated between the touch sensing circuit layer 307 and the conductive layer 314, corresponding safe interval is the minimum safe interval; and if no background capacitance is generated between the touch sensing circuit layer 307 and the conductive layer 314, the corresponding safe interval is the maximum safe interval. In addition, the supporting layer 312 is further integrated with an adhesive layer 310 to jointly form the thickness, which is resistant to background capacitance. Usually, the safe interval can be set as 0.03 mm-3.0 mm.

In above embodiment, the touch sensing device 30 further comprises a substrate 300. The touch sensing circuit layer 307 can be disposed on a lower surface 300b of the substrate 300; the shielding structure 315 and the touch sensing circuit layer 307 are disposed at the same side of the substrate 300. Besides, the touch sensing circuit layer 307 and the shielding structure 315 can also be disposed respectively at two sides of the substrate 300.

Structure and material of the touch sensing circuit layer 307 are same as those of the touch sensing circuit layer 207 shown in FIG. 2. Besides, the touch sensing device 30 also comprises a flexible printed circuit 320 which has a grounding pad 321. Structure and connection of the flexible printed circuit 320 are same as those of the flexible printed circuit 220 shown in FIG. 2.

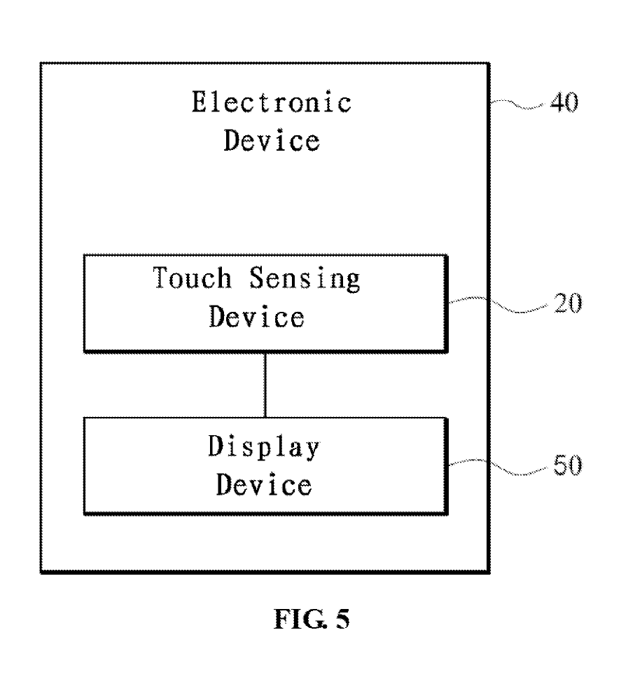

FIG. 5 shows a schematic block diagram of an electronic device which has a touch sensing device in accordance with another embodiment of the present disclosure. In the preferred embodiment, an electronic device 40 can be applied to a mobile phone, a digital camera, a laptop, a personal digital assistant, a desktop or a TV set. The electronic device 40 comprises a touch sensing device 20 (as shown in FIG. 2) and a display device 50, wherein the touch sensing device 20 is disposed on and electrically coupled to the display device 50. In the preferred embodiment, a substrate 200, a touch sensing circuit layer 207 and a conductive layer 214 of the touch sensing device 20 can be made of transparent materials. Moreover, the display device 50 can be a liquid crystal display (LCD) or a light-emitting display (LED), such as an in-plane switching LCD or an organic light-emitting display (OLED). Besides, the touch sensing device 20 in the electronic device 40 shown in FIG. 5 can also be replaced with the touch sensing device 30 shown in FIG. 4.

While certain embodiments have been shown and described, various modifications and substitutions can be made thereto without departing from the spirit and scope of the disclosure. Therefore, it is to be understood that the present disclosure has been described by way of illustration and not limitations.

What is claimed is:

1. A touch sensing device, comprising:
a touch sensing circuit layer disposed on a lower surface of a substrate; and
a shielding structure disposed under the touch sensing circuit layer;
wherein the shielding structure comprises a conductive layer and a supporting layer.

2. The touch sensing device of claim 1, wherein the supporting layer has resistance to background capacitance and has a thickness that forms a safe interval between the touch sensing circuit layer and the conductive layer.

3. The touch sensing device of claim 2, wherein the safe interval is in the range of 0.03 mm-3.0 mm.

4. The touch sensing device of claim 1, further comprising an adhesive layer sandwiched between the touch sensing circuit layer and the shielding structure.

5. The touch sensing device of claim 4, wherein the supporting layer is sandwiched between the adhesive layer and the conductive layer.

6. The touch sensing device of claim 4, wherein the conductive layer is sandwiched between the adhesive layer and the supporting layer.

7. The touch sensing device of claim 1, wherein the touch sensing circuit layer comprises:
an electric connection layer;
a sensing electrode layer; and
a capacitive dielectric layer sandwiched between the electric connection layer and the sensing electrode layer.

8. The touch sensing device of claim 7, wherein the sensing electrode layer comprises a plurality of sensing electrodes arranged along two different directions, and the sensing electrodes along one of the two directions are connected by the electric connection layer.

9. The touch sensing device of claim 1, wherein the touch sensing circuit layer comprises:
a first sensing electrode layer;
a second sensing electrode layer; and
a capacitive dielectric layer sandwiched between the first sensing electrode layer and the second sensing electrode layer.

10. The touch sensing device of claim 9, wherein the first sensing electrode layer comprises a plurality of first sensing electrodes arranged along a first direction and the second sensing electrode layer comprises a plurality of second sensing electrodes arranged along a second direction.

11. The touch sensing device of claim 1, further comprising a flexible printed circuit electrically connected to the conductive layer.

12. The touch sensing device of claim 11, wherein the conductive layer is electrically connected to a grounding pad of the flexible printed circuit through a connection layer.

13. The touch sensing device of claim 1, wherein the supporting layer is made of glass.

14. The touch sensing device of claim 1, wherein thickness of the supporting layer is in the range of 0.05 mm-2.0 mm.

15. The touch sensing device of claim 1, wherein thickness of the conductive layer is in the range of 0.05 mm-0.3 mm.

16. The touch sensing device of claim 4, wherein thickness of the adhesive layer is in the range of 0.03 mm-1.0 mm.

17. An electronic device, comprising:
a display device; and
a touch sensing device disposed on and electrically coupled to the display device, comprising:
a touch sensing circuit layer disposed on a lower surface of a substrate; and
a shielding structure disposed under the touch sensing circuit layer; wherein the shielding structure comprises a conductive layer and a supporting layer.

18. The electronic device of claim 17, wherein the substrate, the sensing electrode layer, and the conductive layer are made of transparent materials.

19. A touch sensing device, comprising:
a touch sensing circuit layer; and
a shielding structure comprising a conductive layer and a supporting layer;
wherein the supporting layer has resistance to background capacitance and has a thickness that forms a safe interval between the touch sensing circuit layer and the conductive layer.

20. The touch sensing device of claim 19, wherein the supporting layer is integrated with an adhesive layer to form resistance to background capacitance.
